(19) United States
(12) Patent Application Publication
(10) Pub. No.: US 2025/0320888 A1
(43) Pub. Date: Oct. 16, 2025

(54) SELF-PIERCING RIVET, METHOD FOR PRODUCING A SELF-PIERCING RIVET, AND METHOD FOR CONNECTING TWO ELEMENTS BY A SELF-PIERCING RIVET

(71) Applicant: Atlas Copco IAS GmbH, Bretten (DE)

(72) Inventor: Briskham Paul, Flintshire (GB)

(21) Appl. No.: 19/097,804

(22) Filed: Apr. 1, 2025

(30) Foreign Application Priority Data
Apr. 12, 2024 (DE) 10 2024 110 292.6

(51) Int. Cl. F16B 19/08; B21J 15/02; C23C 18/16; C23C 18/32; F16B 19/04

(52) U.S. Cl. CPC F16B 19/086; B21J 15/025; C23C 18/1692; C23C 18/32; F16B 2019/045

(57) ABSTRACT

The invention relates to a self-piercing rivet for connecting at least two elements. The self-piercing rivet has a coating. At least one component of the coating has a melting temperature of at least 450° C., and/or the coating comprises nickel. A method for producing a self-piercing rivet includes, providing a self-piercing rivet blank, applying a coating to the self-piercing rivet blank by a chemical coating method, and obtaining the self-piercing rivet.

### CROSS-REFERENCE TO RELATED APPLICATIONS

This application claims priority to German Patent Application No. 10 2024 110 292.6, filed on Apr. 12, 2024, which is incorporated by reference herein in its entirety.

### FIELD OF INVENTION

The present disclosure relates to a self-piercing rivet, a method for producing a self-piercing rivet, and a method for connecting two elements by a self-piercing rivet.

### BACKGROUND

Punched rivets for connecting, for example, two metal sheets are known. Compared with other riveting methods, a pre-punching of the metal sheets can be dispensed with in the case of punched riveting. In this case, the rivet element (punched rivet) serves as a disposable cutting punch and is itself shaped in this case. The metal sheets to be connected are placed on a die. The rivet element is fed to the joining point, and the joining point is fixed by placing the hold-down device during the feed. In the subsequent joining operation, the punched rivet punches through at least the upper sheet metal part and plastically shapes the lower sheet metal part to form a closing head.

Increasingly, ultra-high strength steels (UHSS) and advanced high strength steels (AHSS) with a high hardness or strength are used. In order to be able to connect these steels to other materials by punched riveting, the steel sheet can be heated in order to facilitate the punched riveting operation.

DE 11 2007 001 331 B4 describes a method for connecting elements. In this case, one of the elements to be connected is heated by a laser in order to improve the formability thereof.

EP 4 253 771 A1 relates to a fastening element for connecting at least two components without a preformed hole. Therein, the fastening region is heated by plasma.

DE 19 630 488 C2 relates to a method and a device for joining by forming, in which the joining parts which are to be connected to one another and are arranged in an overlapping manner are plastically shaped locally with the aid of a joining tool consisting of punch, hold-down device and die and with or without the use of an auxiliary joining part. The joining parts can be heated by inductive heating.

Known punched rivets can fail at an elevated temperature of the metal sheets during the joining, with the result that the connection of the metal sheets can be defective.

### SUMMARY

It is an object of the present disclosure to provide a self-piercing rivet by which a low-failure connection of two elements, at least one of which has a high hardness and/or high strength, is enabled or improved. It is a further object of the present disclosure to provide a self-piercing rivet by which a low-failure connection of two elements is enabled or improved if at least one of the elements has an elevated temperature during the use of the self-piercing rivet. It is a further object of the present disclosure to provide a method by which a connection of two elements is improved, in particular if one of the elements has a high hardness and/or high strength, or if at least one of the elements has an elevated temperature during the use of the self-piercing rivet.

At least one of the objects is achieved by the respective features of the independent claims. Preferred embodiments are specified in the dependent claims and the description.

A self-piercing rivet for connecting at least two elements is specified. The self-piercing rivet has a coating. At least one component of the coating has a melting temperature of at least 450° C. Alternatively or additionally, the coating comprises nickel.

Furthermore, a method for producing a self-piercing rivet is specified. The method comprises the steps of: providing a self-piercing rivet blank; applying a coating to the self-piercing rivet blank by a chemical coating method; and obtaining the self-piercing rivet.

The self-piercing rivet can be any self-piercing rivet disclosed herein.

Furthermore, a method for connecting at least two elements by a self-piercing rivet is specified. The self-piercing rivet has a coating. The self-piercing rivet can be any self-piercing rivet disclosed herein. The method comprises the steps of: providing the at least two elements, heating a surface of at least one of the elements, and connecting the two elements by the self-piercing rivet. A melting temperature of at least one component of the coating is above a melting temperature of at least one of the elements. Alternatively or additionally, a melting temperature of at least one component of the coating is above a recrystallization temperature of at least one of the elements.

It has been found that crack formation in the self-piercing rivet or breakage of the self-piercing rivet can be reduced or avoided by using the special coating. If two elements, e.g. two metal components, are connected by a conventional self-piercing rivet and at least one of the elements is heated by means of the self-piercing rivet before the connection of the elements in order to reduce the hardness or strength of one of the elements, the conventional self-piercing rivets can have cracks or even (partially) break. As a result, the strength of the connection of the elements is reduced or not ensured. This problem is intensified by the fact that cracks in the self-piercing rivets or breakages thereof are not always visible. The cracks in the self-piercing rivets or breakages thereof can often be reliably determined only by a destructive investigation. As a result, there is an uncertainty in the connection with conventional self-piercing rivets as to whether the connection is sufficiently strong. Furthermore, the connection can fail only after some time and/or under load.

The elements (also referred to as joining elements) can be metal elements, in particular metal components or metal sheets. In particular, the elements are two different metal elements. The metal elements can differ by their composition (e.g. by their alloy), by their physical properties and/or by their shape (e.g. by their thickness). Preferably, at least one of the elements is a steel element, in particular a UHSS or AHSS steel element. At least one of the elements can be an aluminum element, for example an aluminum casting.

The self-piercing rivet can be provided completely with the coating. The entire surface of the self-piercing rivet can be provided with the coating. In one or more cavities of the self-piercing rivet, the coating can be thinner than outside the cavity or cavities. Likewise, the coating cannot be present in the one or more cavities. Preferably, at least the outer surfaces of the self-piercing rivet are provided completely with the coating.

The coating can comprise different components. Alternatively, the coating can comprise exactly or at most one component.

The self-piercing rivet can be a solid self-piercing rivet. In the case of a solid self-piercing rivet, the joining elements are severed by the solid self-piercing rivet and the resulting recess is filled by the solid self-piercing rivet. The solid self-piercing rivet can have no recess or no cavity.

The self-piercing rivet can be a semi-hollow self-piercing rivet. In the case of a semi-hollow self-piercing rivet, one of the joining elements is severed and the lower joining element is deformed. At the same time, the semi-hollow self-piercing rivet is deformed. The semi-hollow self-piercing rivet can have a recess or a cavity. In particular, the semi-hollow self-piercing rivet has a substantially cylindrical cavity. The cavity can be open only or exactly on one side with respect to the surroundings.

The self-piercing rivet can be a hollow self-piercing rivet. In the case of a hollow self-piercing rivet, in turn not all joining elements are severed. In contrast to a semi-hollow self-piercing rivet, the hollow self-piercing rivet has a continuous recess or a continuous cavity. The recess or the cavity can be open on at least two sides with respect to the surroundings.

The melting temperature of the at least one component can be at least 475° C., preferably at least 500° C., preferably at least 550° C., preferably at least 600° C., preferably at least 650° C., preferably at least 700° C., preferably at least 750° C., preferably at least 800° C., preferably at least 850° C., preferably at least 900° C., preferably at least 950° C., preferably at least 1000° C., preferably at least 1050° C., preferably at least 1100° C., preferably at least 1150° C., preferably at least 1200° C., preferably at least 1250° C., preferably at least 1300° C., preferably at least 1350° C., preferably at least 1400° C., preferably at least 1425° C.

The melting temperature of the at least one component can be at most 3000° C., preferably at most 2900° C., preferably at most 2800° C., preferably at most 2700° C., preferably at most 2600° C., preferably at most 2500° C., preferably at most 2400° C., preferably at most 2300° C., preferably at most 2200° C., preferably at most 2100° C., preferably at most 2000° C., preferably at most 1900° C., preferably at most 1800° C., preferably at most 1700° C., preferably at most 1600° C., preferably at most 1500° C.

The melting temperature of the at least one component can be between 450° C. and 3000° C., preferably between 500° C. and 2800° C., preferably between 600° C. and 2600° C., preferably between 700° C. and 2400° C., preferably between 800° C. and 2200° C., preferably between 900° C. and 2100° C., preferably between 1000° C. and 2000° C., preferably between 1100° C. and 1800° C., preferably between 1200° C. and 1700° C., preferably between 1300° C. and 1600° C., preferably between 1400° C. and 1500° C.

The coating can comprise the at least one component and at least one further component. The at least one component can be a metal. The at least one further component can be a (different) metal or a non-metal. In particular, the at least one further component is phosphorus.

The coating can comprise nickel. Nickel can be the at least one component. Preferably, the coating comprises nickel and at least one further component. The at least one further component can be a metal (different from nickel) or a non-metal. The at least one further component can be phosphorus.

Preferably, the coating comprises nickel and phosphorus.

The melting temperature of the coating can be at least 450° C., preferably at least 475° C., preferably at least 500° C., preferably at least 550° C., preferably at least 600° C., preferably at least 650° C., preferably at least 700° C., preferably at least 750° C., preferably at least 800° C., preferably at least 850° C.

The melting temperature of the coating can be at most 1700° C., preferably at most 1600° C., preferably at most 1550° C., preferably at most 1500° C., preferably at most 1450° C., preferably at most 1400° C., preferably at most 1350° C., preferably at most 1300° C., preferably at most 1250° C., preferably at most 1200° C., preferably at most 1150° C., preferably at most 1100° C., preferably at most 1050° C.

The melting temperature of the coating can be between 450° C. and 1400° C., preferably between 500° C. and 1350° C., preferably between 550° C. and 1300° C., preferably between 600° C. and 1250° C., preferably between 650° C. and 1200° C., preferably between 700° C. and 1150° C., preferably between 750° C. and 1100° C., preferably between 800° C. and 1050° C., preferably between 850° C. and 1000° C.

The coating can comprise at least 50% by weight, preferably at least 55% by weight, preferably at least 60% by weight, preferably at least 65% by weight, preferably at least 70% by weight, preferably at least 75% by weight, preferably at least 80% by weight, preferably at least 85% by weight, of the at least one component, in particular nickel.

The coating can comprise at most 95% by weight, preferably at most 92.5% by weight, preferably at most 90% by weight, preferably at most 87.5% by weight, of the at least one component, in particular nickel.

The coating can comprise between 50% by weight and 95% by weight, preferably between 55% by weight and 95% by weight, preferably between 60% by weight and 95% by weight, preferably between 65% by weight and 92.5% by weight, preferably between 70% by weight and 90% by weight, preferably between 75% by weight and 90% by weight, preferably between 80% by weight and 80% by weight, of the at least one component, in particular nickel.

The coating can comprise at least one further component, in particular phosphorus.

In particular, the coating comprises at least 3% by weight, preferably at least 4% by weight, preferably at least 5% by weight, preferably at least 6% by weight, preferably at least 7% by weight, preferably at least 8% by weight, preferably at least 9% by weight, preferably at least 10% by weight, preferably at least 11% by weight, preferably at least 12% by weight, preferably at least 13% by weight, preferably at least 14% by weight, of the at least one further component, in particular phosphorus.

The coating can comprise at most 40% by weight, preferably at most 35% by weight, preferably at most 30% by weight, preferably at most 25% by weight, preferably at most 20% by weight, preferably at most 18% by weight, preferably at most 16% by weight, preferably at most 15% by weight, of the at least one further component, in particular phosphorus.

The coating can comprise between 4% by weight and 18% by weight, preferably between 5% by weight and 18% by weight, preferably between 6% by weight and 18% by weight, preferably between 7% by weight and 18% by weight, preferably between 8% by weight and 18% by weight, preferably between 9% by weight and 18% by weight, preferably between 10% by weight and 18% by weight, preferably between 11% by weight and 17% by weight, preferably between 12% by weight and 16% by weight, preferably between 13% by weight and 15% by weight, of the at least one further component, in particular phosphorus.

The at least one further component can be boron. All features disclosed herein with respect to phosphorus can be valid for boron. In other words, in this disclosure, phosphorus can be replaced by boron.

The coating can have a density between 5 g/cm³ and 10 g/cm³, preferably between 6 g/cm³ and 9 g/cm³, preferably between 7 g/cm³ and 8 g/cm³, preferably between 7.5 g/cm³ and 8.5 g/cm³, preferably between 7 g/cm³ and 8 g/cm³.

The coating can have a Knoop hardness, in particular determined according to ASTM E384 (100 g), between 250 and 1500, preferably between 300 and 1400, preferably between 350 and 1300, preferably between 400 and 1200, preferably between 400 and 1100, preferably between 400 and 1000, preferably between 450 and 900, preferably between 500 and 850.

The coating can have a Rockwell hardness (Rockwell C) between 30 and 80, preferably between 35 and 75, preferably between 40 and 70, preferably between 45 and 65.

The coating can be applied or can be applied by a chemical coating method. The chemical coating method can comprise a redox reaction.

The chemical coating method can comprise at least one chemical reaction. By the chemical coating method, nickel, preferably a nickel alloy, particularly preferably a nickel-phosphorus alloy or a nickel-boron alloy, can be applied to a surface of the self-piercing rivet. For this purpose, the self-piercing rivet can be introduced into a solution. The solution can contain a nickel salt, e.g. nickel sulfate, and a reducing agent. The reducing agent can comprise phosphorus or boron. For example, hypophosphite (H₂PO₂⁻) or borohydride (BH₄⁻) can be used as reducing agent.

Before the coating of the self-piercing rivet, the surface of the self-piercing rivet can be cleaned chemically and/or mechanically. Likewise, the surface of the self-piercing rivet can be activated by imparting a hydrophilic property thereto. Likewise, the surface of the self-piercing rivet can be activated by providing the surface of the self-piercing rivet with a (thin) metal layer.

After the coating, the coated surface can be provided with an anti-oxidation layer and/or an anti-starting layer.

The chemical coating method can comprise electroless nickel plating (also referred to as chemical nickel layers or electroless nickel plating).

After the application of the coating, the self-piercing rivet or the self-piercing rivet blank can be thermally treated. The thermal treatment can take place in a furnace. Likewise, the thermal treatment can take place in a bath, for example an oil bath.

The self-piercing rivet or the self-piercing rivet blank can be thermally treated at a temperature of at most 350° C. In particular, the self-piercing rivet or the self-piercing rivet blank is thermally treated at a temperature of at most 300° C., preferably of at most 250° C., preferably of at most 200° C. Preferably, the self-piercing rivet or the self-piercing rivet blank is thermally treated at a temperature between 100° C. and 300° C., more preferably between 150° C. and 250° C., more preferably between 180° C. and 220° C.

The self-piercing rivet or the self-piercing rivet blank can be thermally treated for a period of at least 6 h, preferably at least 12 h, preferably at least 18 h, preferably at least 24 h. The self-piercing rivet or the self-piercing rivet blank can be thermally treated for a period of at most 48 h, preferably at most 42 h, preferably at most 36 h, preferably at most 30 h, preferably at most 26 h.

Preferably, the self-piercing rivet or the self-piercing rivet blank is thermally treated for a period of between 6 h and 42 h, more preferably between 12 h and 36 h, more preferably between 18 h and 30 h, more preferably between 22 h and 26 h.

The thermal treatment of the self-piercing rivet or of the self-piercing rivet blank can begin or take place within a period of at most 24 h after the application of the coating to the self-piercing rivet blank. In particular, the thermal treatment of the self-piercing rivet or of the self-piercing rivet blank can begin or take place within a period of at most 18 h, preferably of at most 12 h, preferably of at most 6 h, after the application of the coating to the self-piercing rivet blank.

In a non-limiting example, the self-piercing rivet or the self-piercing rivet blank can take place after the coating within 6 h at a temperature of 200° C.±5° C. for a duration of 24 h.

Hydrogen can escape from the self-piercing rivet as a result of the thermal treatment, as a result of which the risk of hydrogen embrittlement of elements connected by the self-piercing rivet is reduced. Nevertheless, the coating is sealed and cured. A timely thermal treatment of the self-piercing rivet after the coating can contribute to allowing hydrogen to escape before the coating cures (completely) and escape of hydrogen is made more difficult by the sealing.

The self-piercing rivet blank can be formed from a wire, for example by a cold forming method, in particular cold solid forming. The wire can be a steel wire. As a result, the self-piercing rivet blank can obtain its basic shape. This basic shape can be substantially identical to the shape of the later (finished) self-piercing rivet. The formed blank can be thermally treated. The self-piercing rivet blank can be cured by the thermal treatment. The surface of the self-piercing rivet can be treated, for example by a blasting method, in particular sand blasting or granulate blasting.

Subsequently, the coating, as described herein, can be applied to the surface of the self-piercing rivet.

After the coating, the thermal treatment described herein can be carried out. As a result, the self-piercing rivet can be produced.

After the production of a multiplicity of self-piercing rivets, the self-piercing rivets can be checked and sorted. For example, the checking and sorting can be carried out using one or more cameras, for example four cameras, and/or a laser. Subsequently, the self-piercing rivets can be packed, for example into sealed bags each having approximately 2000 self-piercing rivets.

The melting temperature of at least one component of the coating can be above the melting temperature of at least one of the elements to be connected. Preferably, the melting temperature of the at least one component of the coating is at least 50° C., more preferably at least 100° C., more preferably at least 150° C., more preferably at least 200° C., more preferably at least 300° C., more preferably at least 400° C., above the melting temperature of the element.

Likewise, the melting temperature of at least one component of the coating can be above the respective melting temperature of the (two) elements to be connected. Preferably, the melting temperature of the at least one component of the coating is at least 50° C., more preferably at least 100° C., more preferably at least 150° C., more preferably at least 200° C., more preferably at least 300° C., more preferably at least 400° C., above the melting temperature of the (two) elements.

The melting temperature of at least one component of the coating can be above a recrystallization temperature of at least one of the elements to be connected. Preferably, the melting temperature of the at least one component of the coating is at least 50° C., more preferably at least 100° C., more preferably at least 150° C., more preferably at least 200° C., more preferably at least 300° C., more preferably at least 400° C., above the recrystallization temperature of the element.

Likewise, the melting temperature of at least one component of the coating can be above a respective recrystallization temperature of the (two) elements to be connected. Preferably, the melting temperature of the at least one component of the coating is at least 50° C., more preferably at least 100° C., more preferably at least 150° C., more preferably at least 200° C., more preferably at least 300° C., more preferably at least 400° C., above the recrystallization temperature of the (two) elements.

The recrystallization temperature can be referred to as that temperature at which a material completely recrystallizes within an observation time. The recrystallization temperature can be 40% or 50% of the melting temperature of the material.

The melting temperature of the coating can be above the melting temperature of at least one of the elements to be connected. Preferably, the melting temperature of the coating is at least 50° C., more preferably at least 100° C., more preferably at least 150° C., more preferably at least 200° C., more preferably at least 300° C., more preferably at least 400° C., above the melting temperature of the element.

Likewise, the melting temperature of the coating can be above the respective melting temperature of the (two) elements to be connected. Preferably, the melting temperature of the coating is at least 50° C., more preferably at least 100° C., more preferably at least 150° C., more preferably at least 200° C., more preferably at least 300° C., more preferably at least 400° C., above the melting temperature of the (two) elements.

The melting temperature of the coating can be above a recrystallization temperature of at least one of the elements to be connected. Preferably, the melting temperature of the coating is at least 50° C., more preferably at least 100° C., more preferably at least 150° C., more preferably at least 200° C., more preferably at least 300° C., more preferably at least 400° C., above the recrystallization temperature of the element.

Likewise, the melting temperature of the coating can be above a respective recrystallization temperature of the (two) elements to be connected. Preferably, the melting temperature of the coating is at least 50° C., more preferably at least 100° C., more preferably at least 150° C., more preferably at least 200° C., more preferably at least 300° C., more preferably at least 400° C., above the recrystallization temperature of the (two) elements.

At least one of the elements to be connected or both elements can have a yield strength, determined according to ISO 6892-1, of at least 1000 MPa, preferably at least 1300 MPa.

At least one of the elements to be connected or both elements can have a tensile strength, determined according to ISO 6892-1, of at least 1200 MPa, preferably at least 1600 MPa.

As a result of the coating of the self-piercing rivet, said self-piercing rivet can advantageously be used for connecting elements with high strength and/or hardness, even if one of the elements or both elements are heated before the use of the self-piercing rivet in order to reduce the strength and/or hardness and to facilitate an use of the self-piercing rivet.

### BRIEF DESCRIPTION OF THE DRAWINGS

The invention is described in detail below with reference to figures.

FIG. 1 shows a cross section of a self-piercing rivet.

FIG. 2A shows schematically a work step when connecting two elements by means of a self-piercing rivet 10.

FIG. 2B shows schematically a work step when connecting two elements by means of a self-piercing rivet.

FIG. 3A shows a connection of two elements by means of a self-piercing rivet 10 from the prior art.

FIG. 3B shows a connection of two elements by means of a self-piercing rivet 10 of the disclosure.

### DETAILED DESCRIPTION

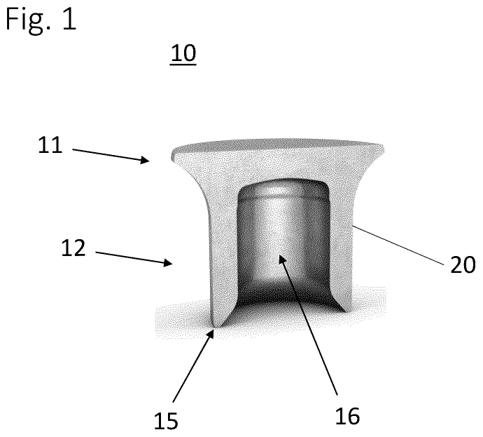

FIG. 1 shows a cross section of a self-piercing rivet 10. The self-piercing rivet 10 shown in FIG. 1 is a semi-hollow self-piercing rivet, but the disclosure is not limited thereto. The self-piercing rivet 10 can likewise be a solid self-piercing rivet or a hollow self-piercing rivet.

The self-piercing rivet 10 can have a self-piercing rivet head 11. A self-piercing rivet shank 12 can adjoin the self-piercing rivet head 11. The self-piercing rivet shank 12 can be formed substantially in the shape of a hollow cylinder. A self-piercing rivet foot 15 can be formed at an axial end of the self-piercing rivet 10 which lies opposite the self-piercing rivet head 11. The thickness (in particular the wall thickness) of the self-piercing rivet shank 12 at the self-piercing rivet foot 15 can be less than in a region in the vicinity of the self-piercing rivet head 11. The thickness (in particular the wall thickness) of the self-piercing rivet shank 12 can decrease towards one end.

The self-piercing rivet 10 can have a cavity 16. The cavity 16 can be delimited or defined by the self-piercing rivet head 11 and the self-piercing rivet shank 12. The cavity 16 can be open on one side with respect to the surroundings. The opening of the cavity 16 can be formed in the region of the self-piercing rivet foot 12.

The self-piercing rivet 10 can be formed rotationally symmetrically.

The self-piercing rivet 10 can have a diameter of at most 15 mm, preferably at most 12.5 mm, more preferably at most 10 mm, more preferably at most 8 mm, more preferably at most 5 mm.

In particular, the self-piercing rivet head 11 can have a diameter of at most 15 mm, preferably at most 12.5 mm, more preferably at most 10 mm, more preferably at most 8 mm. The self-piercing rivet shank 12 can have a diameter of at most 15 mm, preferably at most 12.5 mm, more preferably at most 10 mm, more preferably at most 8 mm, more preferably at most 6 mm.

The self-piercing rivet 10 can have a length (perpendicular to the diameter) of at most 30 mm, preferably at most 25 mm, more preferably at most 20 mm, more preferably at most 15 mm, more preferably at most 10 mm, more preferably at most 7.5 mm, more preferably at most 5 mm.

The surface of the self-piercing rivet 10 is preferably provided with a coating 20. The coating 20 can be any coating disclosed herein. The coating 20 can be applied to the self-piercing rivet 10 at least in the region of the self-piercing rivet shank 12. Preferably, the entire surface of the self-piercing rivet 10 is provided with the coating 20. Likewise, the coating 20 can be applied only to outer surfaces of the self-piercing rivet 10. One cavity or a plurality of cavities of the self-piercing rivet 10 cannot be provided with the coating 20 or the coating 20 can be thinner in the cavity or cavities than on the outer surfaces of the self-piercing rivet 10.

Particularly preferably, the coating 20 is a nickel-phosphorus coating. The coating 20 can be applied by electroless nickel plating (“electroless nickel plating”).

The self-piercing rivet 10 can comprise steel. Preferably, the self-piercing rivet 10, apart from the coating 20, consists of steel.

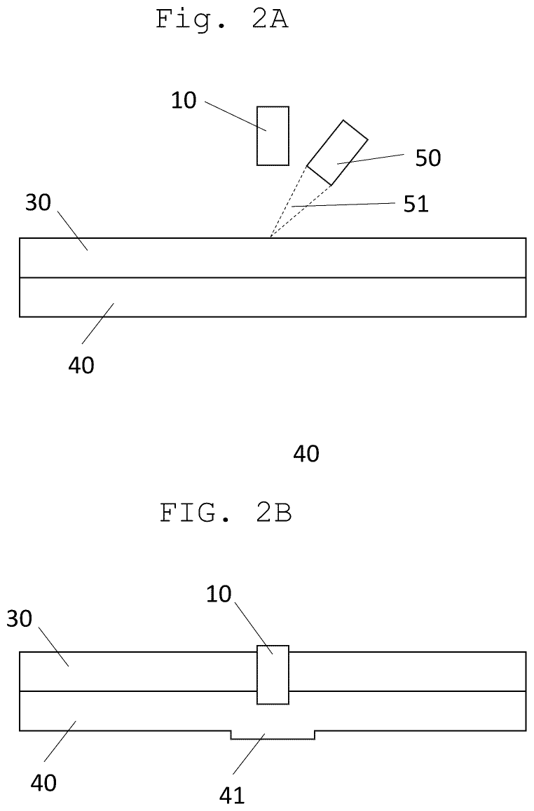

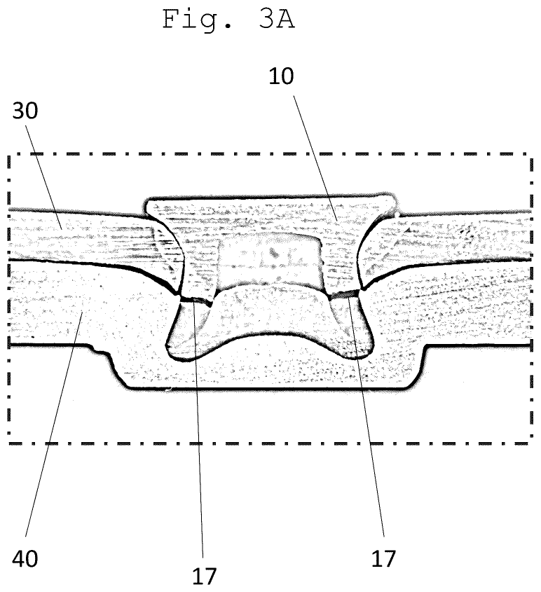

FIGS. 2A and 2B show method steps in the connection of at least two elements 30, 40.

In FIG. 2A, a first element 30 and a second element 40 are provided. The first and second elements 30, 40 can be positioned and possibly held relative to one another. The first element 30 can at least partially contact the second element 40.

The first element 30 can be a steel component. The second element 40 can be an aluminum component. The thickness of the first element 30 can be between 1.0 mm and 2.0 mm. Preferably, the thickness of the first element 30 is approximately 1.5 mm. The thickness of the second element 40 can be between 2.0 mm and 6.0 mm, preferably between 2.0 mm and 3.0 mm. Preferably, the thickness of the second element 40 is approximately 2.5 mm.

At least one of the first and second elements 30, 40 can be heated by a heating device 50. This is done before the self-piercing rivet 10 is used for connecting the first and second elements 30, 40.

The heating device 50 can comprise a laser. The heating device 50 can be configured to generate a laser beam 51 and to irradiate the laser beam 51 onto the surface of the first element 30 and/or the surface of the second element 40. As a result, the surface of the element onto whose surface the laser beam 51 is irradiated or has been irradiated can be heated. In addition, a region of the element onto whose surface the laser beam 51 is irradiated or has been irradiated can be heated in the vicinity of the surface. If the laser beam 51 is irradiated onto the surface of the element, the element onto whose surface the laser beam 51 is not irradiated can likewise be heated, for example by (conductive) heat conduction.

The heating device 50 can comprise a resistive element. The resistive element can be heated by electric current. The resistive element can contact a surface of the first and/or second element 30, 40 and heat the latter.

The heating device 50 can likewise comprise an inductive element. The inductive element can be configured to generate a magnetic field. The first and/or second element 30, 40 can be heated by the magnetic field.

The first and/or second element 30, 40 can be heated up to a temperature below the melting temperature of the first and/or second element 30, 40. Preferably, the first and/or second element 30, 40 is heated up to a temperature of up to 80% of the melting temperature of the first and/or second element 30, 40. The first and/or second element 30, 40 can be heated up to a temperature of at least 500° C., preferably at least 600° C., preferably at least 700° C., preferably at least 800° C., preferably at least 900° C., preferably at least 1000° C., preferably at least 1100° C., preferably at least 1200° C.

The first and/or second element 30, 40 can be heated up to a temperature above a recrystallization temperature of the first and/or second element 30, 40. Preferably, the first and/or second element 30, 40 is heated up to a temperature of at least 50° C., preferably at least 100° C., preferably at least 150° C., preferably at least 200° C., preferably at least 250° C., preferably at least 300° C., preferably at least 350° C., preferably at least 400° C., above a recrystallization temperature of the first and/or second element 30, 40.

As a result of the heating, the strength and/or hardness of the first and/or second element 30, 40 can be reduced.

The self-piercing rivet 10 can be held by a hold-down device (not shown). Furthermore, a die (not illustrated) can be positioned opposite the hold-down device.

FIG. 2B shows elements 30, 40 connected by the self-piercing rivet 10. In order to connect the elements 30, 40, the self-piercing rivet 10 can be introduced into the surface of the first element 30. For this purpose, the punch which is enclosed by the hold-down device can apply a force to the self-piercing rivet 10, in particular the self-piercing rivet head 11, and drive the self-piercing rivet 10 into the first element 30. By introducing the self-piercing rivet 10 into the first element 30, 40, a portion of the first element 30 can be punched out. The punched-out portion of the first element 30 can be pressed in the direction of the second element 40. The self-piercing rivet 10 can penetrate only partially or at most partially into the second element 40. A portion of the second element 40 can deform plastically. As a result of the penetration of the self-piercing rivet 10 into the first and second elements 30, 40, a bulge 41 (also referred to as closing head) can form on the second element 40. The bulge 41 can protrude beyond the surface of the second element 40. The shape of the bulge 41 can be defined substantially by the shape of the die. The die can bear against the surface of the second element 40 when the self-piercing rivet 10 is introduced into the first and second elements 30, 40. The shape of the bulge 41 can correspond substantially to the shape of a recess of the die.

The introduction of the self-piercing rivet 10 into the first and/or second element 30, 40 can take place without pre-punching.

As a result of the heating of the first and/or second element 30, 40, the strength and/or hardness of the first and/or second element 30, 40 is reduced, with the result that an introduction of the self-piercing rivet 10 is facilitated or enabled. For this purpose, relatively thin or relatively small self-piercing rivets 10 can also be used. However, the self-piercing rivet 10 is also heated as a result.

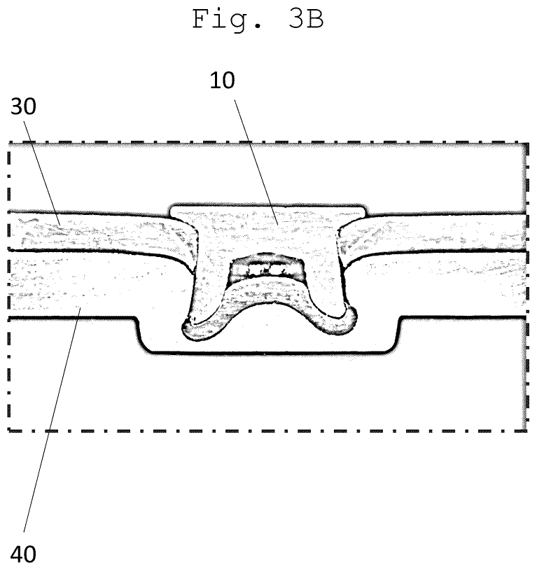

FIGS. 3A and 3B each show a connection of two elements 30, 40 by means of a self-piercing rivet 10. In this case, a known method or a known self-piercing rivet 10 was used in FIG. 3A. In FIG. 3B, the method according to the invention or a self-piercing rivet 10 according to the invention was used.

The first element 30 of the connection shown in FIGS. 3A and 3B is a steel element with a thickness of approximately 1.5 mm. The second element 40 of the connection shown in FIGS. 3A and 3B is an aluminum element with a thickness of approximately 2.5 mm. The surface of the first element 30 has a temperature of approximately 1200° C. during the joining process and the second element 40 has a temperature of approximately 300° C. during the joining process.

The self-piercing rivet 10 of the connection shown in FIG. 3a is provided with a coating which contains zinc, tin and aluminum. The self-piercing rivet 10 of the connection shown in FIG. 3b is provided with a coating according to the invention which contains, in particular, nickel and phosphorus, and is applied specifically by electroless nickel plating (“electroless nickel plating”).

As can be seen in FIG. 3A, the self-piercing rivet 10 has cracks 17. Cracks 17 in self-piercing rivets 10 have been found in a plurality of comparable or identical investigations. The stability of the connection of the elements 30, 40 is restricted or defective as a result of the cracks 17. The connection of the elements 30, 40 can fail, in particular under load.

No cracks have been found in the self-piercing rivet 10 according to the invention, as shown in FIG. 3B. The connection of the elements 30, 40 using the self-piercing rivet 10 according to the invention or the method according to the invention appears to be error-free.

Without wishing to be bound by a theoretical explanation, it is assumed that the cracks 17 in the known self-piercing rivet 10 could have resulted at least partially from liquid metal embrittlement. Liquid metal embrittlement is a phenomenon in which certain ductile metals suffer a drastic loss of tensile ductility or break brittle when they are exposed to certain liquid metals. This could have taken place by partial melting of the coating of the known self-piercing rivet 10, as a result of which the self-piercing rivet 10 has lost its mechanical properties. This effect can be avoided or reduced by the coating 20 according to the invention.

What is claimed is:

1. A self-piercing rivet for connecting at least two elements, wherein the self-piercing rivet has a coating, and wherein:
(i) at least one component of the coating has a melting temperature of at least 450° C., and
(ii) the coating comprises nickel.

2. The self-piercing rivet according to claim 1, wherein the self-piercing rivet is a solid self-piercing rivet, a semi-hollow self-piercing rivet or a hollow self-piercing rivet.

3. The self-piercing rivet according to claim 1, wherein the melting temperature of the at least one component of the coating is at least 1300° C.

4. The self-piercing rivet according to claim 1, wherein the melting temperature of the coating is at least 850° C.

5. The self-piercing rivet according to claim 1, wherein the coating contains nickel to an extent of at least 80% by weight.

6. The self-piercing rivet according to claim 1, wherein the coating contains phosphorus to an extent of at least 12% by weight.

7. The self-piercing rivet according to claim 1, wherein the coating is applied by a chemical coating method.

8. A method for producing a self-piercing rivet, the method comprising:
providing a self-piercing rivet blank;
applying a coating to the self-piercing rivet blank by a chemical coating method; and
obtaining the self-piercing rivet.

9. The method according to claim 8, wherein the chemical coating method comprises electroless nickel plating.

10. The method according to claim 8, wherein the self-piercing rivet blank is thermally treated after the application of the coating at a temperature of at most 350° C. and for a duration of at most 48 hours.

11. The method according to claim 10, wherein the thermal treatment begins at most 24 hours after the application of the coating to the self-piercing rivet blank.

12. A method for connecting at least two elements by a self-piercing rivet with a coating, the method comprising:
providing the at least two elements,
heating a surface of at least one of the elements, and
connecting the two elements by the self-piercing rivet, wherein a melting temperature of at least one component of the coating is above a melting and recrystallization temperature of at least one of the elements.

13. The method according to claim 12, wherein a melting temperature of the coating is above the melting and recrystallization temperature of at least one of the elements.

14. The method according to claim 12, wherein at least one of the elements has a yield strength, determined according to ISO 6892-1, of at least 1300 MPa, and a tensile strength, determined according to ISO 6892-1, of at least 1600 MPa.
